(19) United States
(12) Patent Application Publication
(10) Pub. No.: US 2025/0203386 A1
(43) Pub. Date: Jun. 19, 2025

(54) STATION INSTALLATION DESIGN METHOD, STATION INSTALLATION DESIGN APPARATUS, AND PROGRAM

(71) Applicant: NIPPON TELEGRAPH AND TELEPHONE CORPORATION, Tokyo (JP)

(72) Inventors: Toshiro NAKAHIRA, Tokyo (JP); Daisuke MURAYAMA, Tokyo (JP); So TAKATANI, Tokyo (JP); Motoharu SASAKI, Tokyo (JP); Kenichi KAWAMURA, Tokyo (JP); Takatsune MORIYAMA, Tokyo (JP)

(21) Appl. No.: 18/834,047

(22) PCT Filed: Feb. 16, 2022
(86) PCT No.: PCT/JP2022/006257

§ 371 Date: Jul. 29, 2024

(51) Int. Cl. H04W 16/18; H04W 24/10

(52) U.S. Cl. CPC H04W 16/18; H04W 24/10

(57) ABSTRACT

In a station installation design method executed by a computer used as a station installation design apparatus that performs station installation design for a wireless system including a plurality of base stations having different wireless systems between at least two base stations, the station installation design method includes a reception power calculation step of calculating reception power from the base station in each terminal to be an evaluation point for each of one or the plurality of base stations arranged in a temporary installation state in a target area, a transmission rate acquisition step of converting each reception power calculated in the reception power calculation step into a transmission rate by using a conversion table prepared for each wireless system, and an arrangement step of changing the base station selected from one or the plurality of base stations in the temporary installation state based on a station installation design evaluation index value in consideration of a cost of the base station to an installation state, and making the terminals which can be accommodated in the selected base station accommodated among the unaccommodated terminals, wherein the reception power calculation step, the transmission rate acquisition step, and the arrangement step are repeatedly executed.

### TECHNICAL FIELD

The present invention relates to station installation design of a base station used in a wireless system.

### BACKGROUND ART

In order to construct a cover area of the wireless system, station installation design is performed to determine an installation location and an antenna direction of the base station. In the station installation design, simulation of radio wave propagation or the like in a service area may be performed after selecting a position of the base station.

In the simulation of the service area, methods such as estimation by an experimental expression (NPL 1) and a ray tracing method (NPL 2) are used.

### CITATION LIST

### Non Patent Literature

[NPL 1] NTTDocomo technical journal Vol 12. No 4, “Station Installation Design in Mobile Communications”, Omatsuzawa, Motoki, Ohori

[NPL 2] NTTDocomo technical journal Vol 15. No 3, “Ray-Tracing Technique Employing Genetic Algorithm for Radio Propagation Prediction”, Tetsuro Imai

### SUMMARY OF INVENTION

### Technical Problem

In recent years, an area where a plurality of base stations of different wireless systems are installed has increased. There is a possibility that a wireless network with efficient communication performance versus cost can be constructed by combining a plurality of wireless systems.

However, since the station installation design is performed based on reception power in conventional technique, communication performance (wireless transmission rate, system capacity, etc.) different for each wireless system and a system cost (base station device price, operation cost, etc.) cannot be considered.

Therefore, in the conventional technique, the station installation design for realizing the wireless network with efficient communication performance versus cost by combining the plurality of wireless systems cannot be performed.

The present invention has been made in view of the above-described point, and an object of the present invention is to provide a technique enabling the station installation design for realizing the wireless network with efficient communication performance versus cost by combining the plurality of wireless systems.

### Solution to Problem

According to the disclosed technique, a station installation design method executed by a computer used as a station installation design device (station installation design apparatus) that performs station installation design for a wireless system including a plurality of base stations having different wireless systems between at least two base stations, the station installation design method includes a reception power calculation step of calculating reception power from the base station in each terminal to be an evaluation point for each of one or the plurality of base stations arranged in a temporary installation state in a target area,
a transmission rate acquisition step of converting each reception power calculated in the reception power calculation step into a transmission rate by using a conversion table prepared for each wireless system, and
an arrangement step of changing the base station selected from one or the plurality of base stations in the temporary installation state based on a station installation design evaluation index value in consideration of a cost of the base station to an installation state, and making terminals which can be accommodated in the selected base station accommodated among the unaccommodated terminals, wherein
the station installation design method in which the reception power calculation step, the transmission rate acquisition step, and the arrangement step are repeatedly executed is provided.

### Advantageous Effects of Invention

According to the disclosed technique, there is provided a technique enabling station installation design for realizing a wireless network with efficient communication performance versus cost by combining a plurality of wireless systems.

### BRIEF DESCRIPTION OF DRAWINGS

FIG. 1 is a diagram for explaining an overview of an embodiment of the present invention.

FIG. 2 is a diagram showing a system configuration of the embodiment of the present invention.

FIG. 3 is a configuration diagram of a station installation design device.

FIG. 4 is a diagram for explaining an overview of operations of the station installation design device.

FIG. 5 is a flowchart for explaining operations of the station installation design device.

FIG. 6 is a diagram showing an example of a conversion table.

FIG. 7 is a diagram showing an example of the conversion table.

FIG. 8 is a diagram showing a hardware configuration example of a device.

### DESCRIPTION OF EMBODIMENTS

Embodiments of the present invention (present embodiment) will be described below with reference to the drawings. The embodiments to be described below is merely examples and an embodiment to which the present invention is applied is not limited to the following embodiments.

### (Problem and Overview of Embodiment)

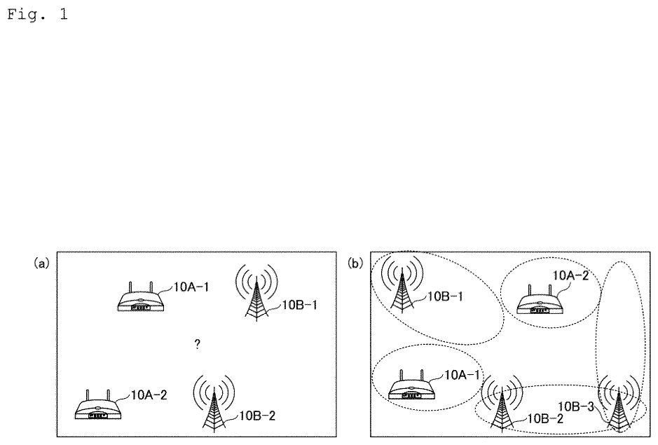

FIG. 1 (a) shows a configuration example of a wireless system (which may be referred to as a wireless communication system) assumed in the present embodiments. However, FIG. 1 (a) shows a situation (situation of conventional technique) in which a station installation design device 100 (station installation design apparatus) described later using technique of the present invention is not used.

As shown in FIG. 1 (a), the present wireless system includes a base station 10A-1, a base station 10A-1, a base station 10B-1, and a base station 10B-2. The base station 10A and the base station 10B have different communication systems.

As an example, the base station 10A is a wireless LAN base station (access point), and the base station 10B is a base station of a cellular network such as 5G. A wireless system including a plurality of base stations of different systems may be referred to as a multi-wireless system.

In the wireless system, station installation design is performed. In the station installation design, in order to efficiently form an appropriate service area in consideration of a peripheral environment of a building or the like, topography, the number of terminals to be accommodated, and the like, an arrangement position and an antenna direction of each base station are determined.

As described above, in the conventional technique, reception power of a signal transmitted from the base station at a terminal side is estimated by an experimental expression or a ray-tracing, and the station installation design is performed based on the reception power.

However, for the wireless system in which base stations having a plurality of different wireless systems exist such as the wireless system shown in FIG. 1 (a), the conventional station installation design method cannot consider both of communication performance (wireless transmission rate, system capacity, etc.) different for each wireless system and a system cost (base station device price, operation cost, etc.) different for each wireless system, so that the station installation design for the wireless network with efficient communication performance versus cost by combining a plurality of wireless systems cannot be performed.

In order to solve the above problem, in the present embodiment, the station installation design device 100 performs the station installation design of the wireless system by executing the following two processes.

(1) A correspondence table between the reception power and the wireless transmission rate is prepared for each wireless system, and the reception power for each wireless system calculated by the ray-trace or the like is converted into the wireless transmission rate.

(2) The cost (base station cost) of each installed base station is defined for each wireless system. A “cover performance versus cost” obtained by dividing cover performance (cover area, the number of accommodated terminals, etc.) calculated based on the wireless transmission rate by the base station cost is calculated and used as an evaluation index. Thus, as shown in FIG. 1 (b), each base station can be appropriately arranged. Note that the “cover performance versus cost” may be referred to as “communication performance versus cost”. The base station cost is, for example, either or both of a base station price and an operation cost.

The transmission rate in the present embodiment may be a transmission rate of uplink communication, a transmission rate of downlink communication, or a transmission rate of both uplink communication and downlink communication.

### System Configuration Example

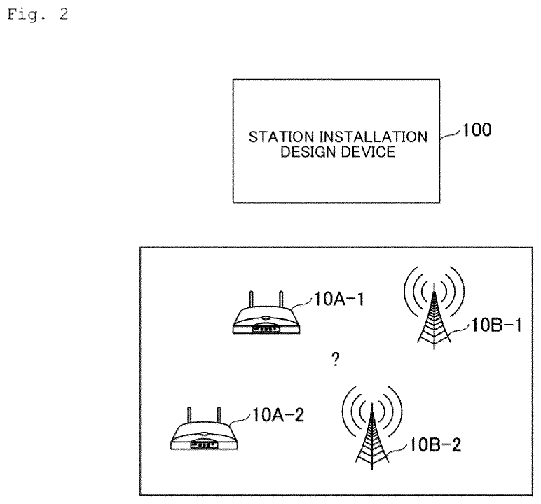

FIG. 2 shows a configuration example of the wireless system to be a target of the station installation design in the present embodiment. As shown in FIG. 2, the present wireless system includes the base station 10A-1, the base station 10A-1, the base station 10B-1, and the base station 10B-2. Note that the wireless system shown in FIG. 2 schematically shows a wireless system including a plurality of base stations of a plurality of different wireless systems. The station installation design device 100 shown in FIG. 2 performs the station installation design for the wireless system.

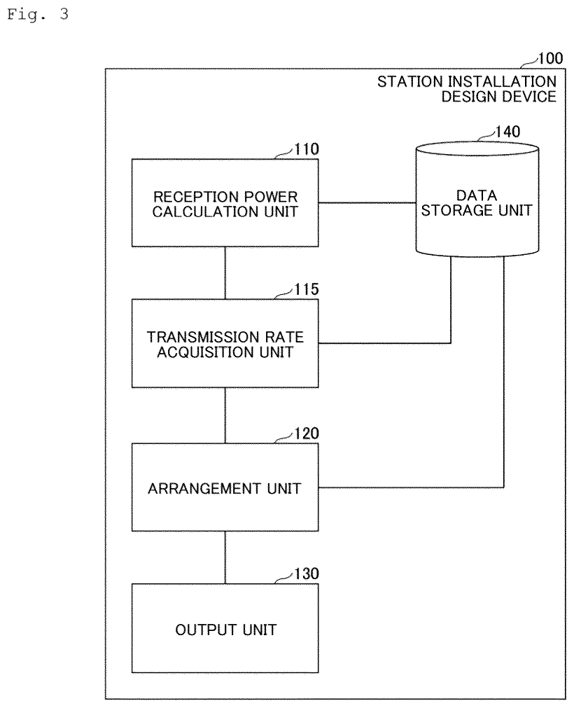

FIG. 3 shows a configuration example of the station installation design device 100. As shown in FIG. 3, the station installation design device 100 includes a reception power calculation unit 110, a transmission rate acquisition unit 115, an arrangement unit 120, an output unit 130, and a data storage unit 140.

### (Operations of Station Installation Design Device 100)

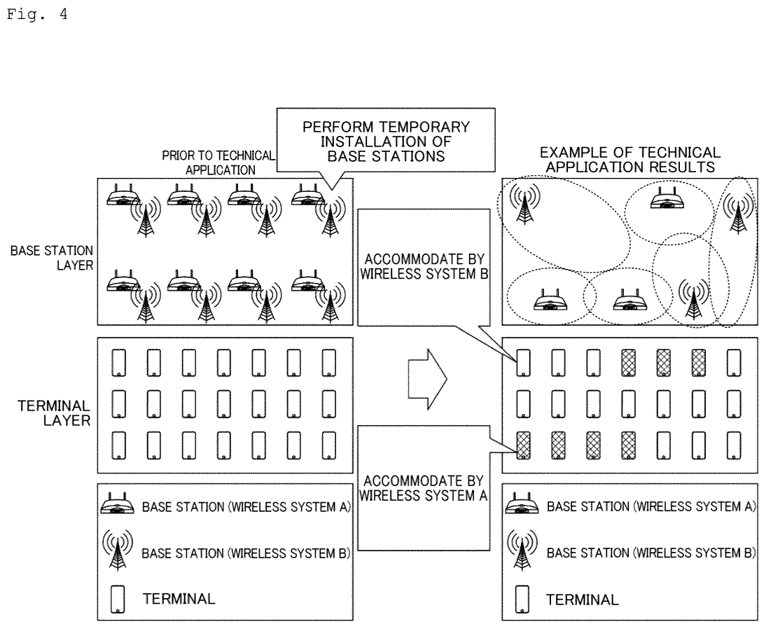

The following will describe an overview of station installation design processing operations by the station installation design device 100 with reference to FIG. 4. FIG. 4 shows an example in which a base station of wireless system A and a base station of wireless system B exist, and each terminal can be connected to both the base station of the wireless system A and the base station of the wireless system B.

First, as shown in a left side of FIG. 4, each base station is temporarily arranged (temporarily installed) at an arbitrary point in a target area. In addition, a plurality of terminals to be evaluation points of the reception power and the transmission rate are arranged in the target area. For example, each terminal is arranged so as to have a terminal distribution assumed in the target area. When the assumed terminal distribution is unknown, the terminals may be uniformly arranged. FIG. 4 shows an example of the case in which the terminals are uniformly arranged.

After starting from an initial state on the left side of FIG. 4, processing of a flowchart to be described later is performed, so that, as exemplified on a right side of FIG. 4, the arrangement of each base station and the terminal accommodated in each base station are determined.

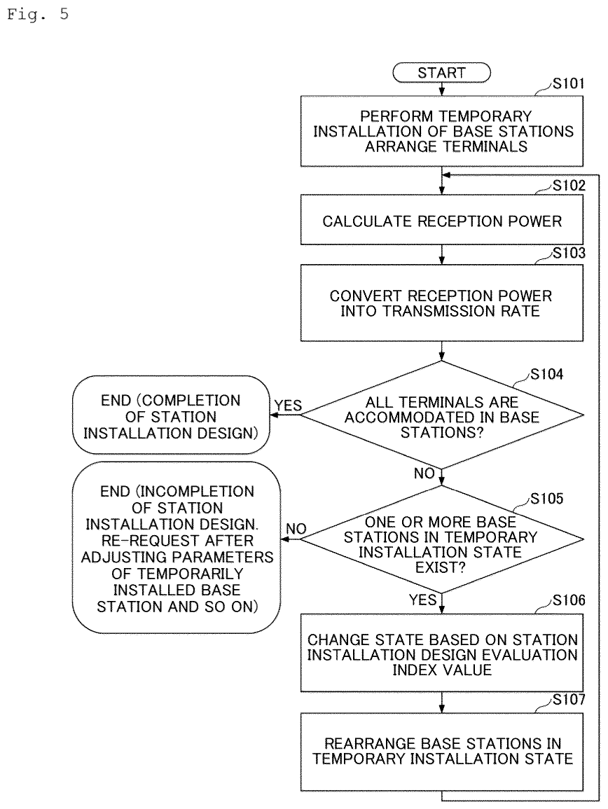

Operations of the station installation design device 100 will be described in more detail in accordance with a procedure of the flowchart in FIG. 5. As a premise of the operations of the flowchart in FIG. 5, the data storage unit 140 stores information on the target area of the station installation design (information necessary for the ray-trace such as topography and a building), information on base stations to be arranged (a wireless system, number, transmission power, cost, etc.), information on terminals (the number of terminals, etc.), the conversion table for each wireless system, or the like.

Note that, in the present embodiment, the position and the antenna direction of the base station are considered with respect to parameters for the installation (arrangement) of the base station, but these parameters are merely examples. For example, in the case of the station installation design, only the position of the base station may be determined without considering the antenna direction (that is, assuming that transmission and reception are possible with the same strength in all directions). Further, in addition to the position and the antenna direction, further parameters may be used to perform the station installation design.

In S101, the arrangement unit 120 temporarily installs each base station at an arbitrary position in the target area of the station installation design, and further arranges a plurality of terminals in the target area of the station installation design as an evaluation point of an area cover. In the temporary installation of the base station, the antenna direction is directed to a predetermined initial direction for the base station whose antenna direction can be changed. Data indicating the arrangement is stored in the data storage unit 140.

In S102, the reception power calculation unit 110 calculates the reception power of the signal (radio wave) transmitted from each base station in each terminal. The reception power calculation may be performed by using the ray-trace method, the experimental expression, or the like. In the present embodiment, it is assumed that the ray-trace method is used.

In S103, the transmission rate acquisition unit 115 converts the reception power from each base station in each terminal into each transmission rate based on the conversion table read from the data storage unit 140, and stores the transmission rate in the data storage unit 140.

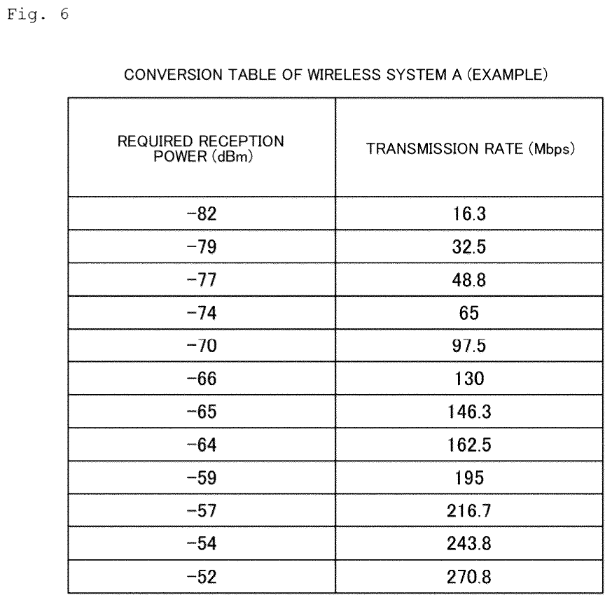

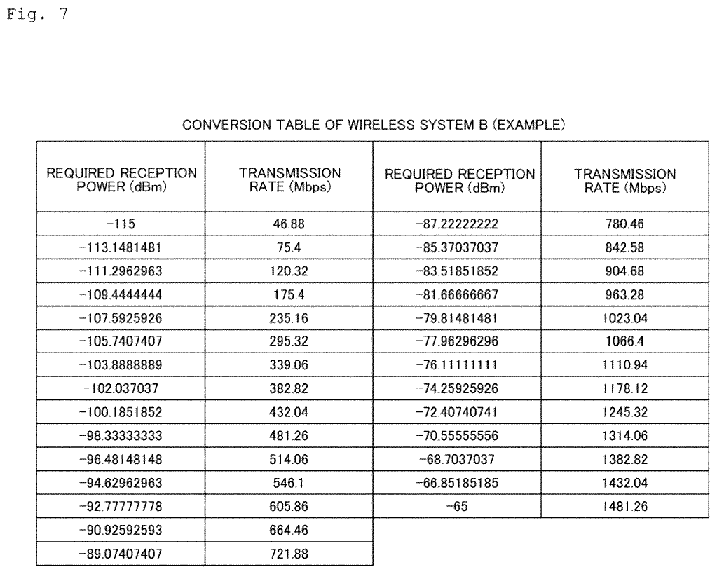

FIG. 6 and FIG. 7 show examples of the conversion tables. FIG. 6 shows the conversion table of the wireless system A, and FIG. 7 shows the conversion table of the wireless system B. The transmission rate acquisition unit 115 uses the conversion table of the wireless system A for the base station of the wireless system A, and uses the conversion table of the wireless system B for the base station of the wireless system B.

In S104, the arrangement unit 120 determines whether all terminals have been accommodated in the base stations. When determination result in S104 is “Yes” (accommodated), the station installation design is completed. The output unit 130 outputs the result of the station installation design (the position of each base station, etc.) and terminates the processing.

When the determination result is “No” in S104, the processing proceeds to S105. In S105, the arrangement unit 120 determines whether or not there are one or more base stations in a temporary installation state. When the determination result in S105 is “No” (zero base stations in the temporary installation state), the station installation design is not completed, and the processing is terminated. In this case, the parameters of the temporarily installed base station or the like are adjusted and the processing is performed again.

When the determination result in step S105 is “Yes”, the processing moves to S106. In S106, the arrangement unit 120 selects one base station having the maximum station installation design evaluation index value among the base stations in the temporary installation state, and changes the state to “installation”. In addition, the arrangement unit 120 changes a state of a terminal that can be accommodated in a selected base station (a base station whose state is changed to “installation”) to “accommodated” among the unaccommodated terminals. The states of the base station and the terminal are stored in the data storage unit 140.

As the station installation design evaluation index value used in the processing of S106, for example, “a value obtained by dividing the number of unaccommodated terminals whose transmission rate that can be received from the selected base station is equal to or more than a predetermined threshold value by the cost of the selected base station (preset for each wireless system)” can be used.

As an example, it is assumed that there are the base station A and the base station B as the base stations in the temporary installation state. It is assumed that the threshold value is 500 Mbps, that there are 60 unaccommodated terminals whose transmission rate that can be received from the base station A is 500 Mbps or more, and that there are 50 unaccommodated terminals whose transmission rate that can be received from the base station B is 500 Mbps or more. It is also assumed that the cost of the base station A is 15 and the cost of the base station B is 10. Since 60/15<50/10 is satisfied, the base station B is selected and the state is changed to “installation”.

In the above example, the threshold value for judging the transmission rate that can be received from the base station is a common value for all the terminals. The threshold value for judging the transmission rate that can be received from the base station may not be the common value to all the terminals. For example, when there is an individual request for each terminal, different values may be set, respectively. The threshold value common to the terminals or the threshold values individual to the terminals is stored in advance in the data storage unit 140, and the arrangement unit 120 reads the threshold value from the data storage unit 140 and uses it.

The above station installation design evaluation index is an example. For example, by arranging evaluation points at high density, area of an area where the transmission rate is equal to or more than the threshold value is obtained, and a value obtained by dividing the area by the cost of the base station may be used as the station installation design evaluation index value.

Further, here, it is assumed that the larger the station installation design evaluation index value, the better, but an index value such that the smaller the station installation design evaluation index value, the better may be used. The “maximum” in the case where the station installation design evaluation index value is larger, and the “minimum” in the case where the station installation design evaluation index value is smaller, may be expressed as “best”.

In the above example, only one base station having the best station installation design evaluation index value is selected, but this is an example. The upper M number of base stations having the good station installation design evaluation index value may be selected. M is a predetermined natural number.

In S106, when the arrangement unit 120 selects the terminal to be accommodated in the selected base station, for example, whether to accommodate the terminal or not may be judged by dividing the transmission rate of the terminal by the number of terminals connected to the selected base station, and whether the result equal to or more than the predetermined threshold value.

For example, it is assumed that the selected base station is the base station B, the terminal 1 is an unaccommodated terminal, and the terminal 2 and the terminal 3 are accommodated terminals in the base station B. It is assumed that the transmission rate of the terminal 1 is 200 Mbps when the terminal 1 is connected to the base station B and the threshold value is 100 Mbps. In this case, since a value obtained by dividing 200 Mbps which is the transmission rate of the terminal 1 by 3 which is the number of terminals is less than the threshold value, the terminal 1 is not selected as a terminal accommodated in the base station B.

The threshold value used for selecting the terminal to be accommodated may be a common value for all the terminals or may be an individual value for each terminal. The threshold value common to the terminals or the threshold values individual to the terminals is stored in advance in the data storage unit 140, and the arrangement unit 120 reads the threshold value from the data storage unit 140 and uses it.

The method of selecting the terminal to be accommodated in the selected base station by the arrangement unit 120 is not limited to the above method. For example, the maximum number of terminals which can be accommodated is set in advance for each base station, and the unaccommodated terminals may be accommodated in the base station in the order of higher transmission rates when connected to the base station which has become “installation” within a range of the maximum number of terminals which can be accommodated or less.

In S107, the arrangement unit 120 rearranges the base station in the temporary installation state (changes the position, the antenna direction, etc. of the base station). Subsequently, processing of $102 and thereafter is performed again. When the base stations in the temporary installation state are rearranged, all the base stations in the temporary installation state may be rearranged, or only some of the base stations among all the base stations in the temporary installation state may be rearranged. For example, the N-th (from the minimum value to the N-th) base stations may be rearranged in the ascending order of the station installation design evaluation index values. N may be 1, or may be a predetermined ratio (for example, 30%) of the number of base stations in the temporary installation state.

Note that the processing of S102 and thereafter may be executed again without changing the arrangement of the temporarily installed base stations determined first, that is, without executing S107 in FIG. 5.

### (Example of Hardware Configuration)

The station installation design device 100 can be realized, for example, by causing a computer to execute a program. The computer may be a physical computer or a virtual machine on a cloud.

That is, the station installation design device 100 can be realized by executing the program corresponding to processing performed by the station installation design device 100 by using hardware resources such as a CPU and a memory built in the computer. The above-described program can be recorded on a computer-readable recording medium (a portable memory, etc.) to be stored and distributed. In addition, the above-described program can also be provided through a network such as the Internet or e-mail.

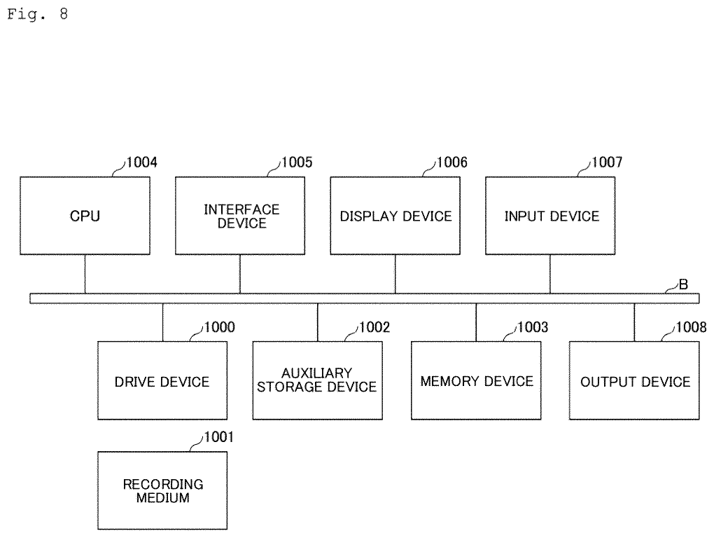

FIG. 8 is a diagram showing a hardware configuration example of the computer. The computer in FIG. 8 includes a drive device 1000, an auxiliary storage device 1002, a memory device 1003, a CPU 1004, an interface device 1005, a display device 1006, an input device 1007, an output device 1008, and the like, which are connected to each other through a bus BS.

The program for realizing processing in the computer is provided by, for example, a recording medium 1001 such as a CD-ROM or a memory card. When the recording medium 1001 that stores the program is set in the drive device 1000, the program is installed from the recording medium 1001 through the drive device 1000 to the auxiliary storage device 1002. However, the program need not necessarily be installed from the recording medium 1001 and may be downloaded from another computer via the network. The auxiliary storage device 1002 stores the installed program and also stores necessary files, data, and the like.

The memory device 1003 reads and stores the program from the auxiliary storage device 1002 when an instruction to start the program is given. The CPU 1004 realizes functions related to the station installation design device 100 in accordance with the program stored in the memory device 1003. The interface device 1005 is used as an interface for connecting to the network or the like. The display device 1006 displays a GUI (Graphical User Interface) and the like by the program. The input device 1007 is constituted by a keyboard and a mouse, buttons, a touch panel, or the like and is used for inputting various operation instructions. The output device 1008 outputs a calculation result.

### Advantageous Effects of Embodiment

By the technique according to the present embodiment, it is possible to perform the station installation design for the wireless network with efficient communication performance versus cost by combining the plurality of wireless systems.

### (Supplements)

The following supplement items are disclosed in relation to the embodiments described above.

### (Supplement Item 1)

A station installation design method executed by a computer used as a station installation design device that performs station installation design for a wireless system including a plurality of base stations having different wireless systems between at least two base stations, the station installation design method includes
a reception power calculation step of calculating reception power from the base station in each terminal to be an evaluation point for each of one or the plurality of base stations arranged in a temporary installation state in a target area,
a transmission rate acquisition step of converting each reception power calculated in the reception power calculation step into a transmission rate by using a conversion table prepared for each wireless system, and
an arrangement step of changing the base station selected from one or the plurality of base stations in the temporary installation state based on a station installation design evaluation index value in consideration of a cost of the base station to an installation state, and making the terminals which can be accommodated in the selected base station accommodated among the unaccommodated terminals, wherein the station installation design method repeatedly executes the reception power calculation step, the transmission rate acquisition step, and the arrangement step.

### (Supplement Item 2)

The station installation design method according to supplement item 1, wherein in repeated execution of the reception power calculation step, the transmission rate acquisition step, and the arrangement step, repeated execution is performed while changing an arrangement of the base station in the temporary installation state.

### (Supplement Item 3)

The station installation design method according to supplement item 1 or 2, wherein in the arrangement step, one base station having the best station installation design evaluation index value is selected among one or the plurality of base stations in the temporary installation state, and the selected base station is changed to the installation state.

### (Supplement Item 4)

The station installation design method according to any one of supplement items 1 to 3, wherein the station installation design evaluation index value is a value obtained by dividing the number of unaccommodated terminals whose transmission rate that can be received from the base station is equal to or more than a predetermined threshold value by the cost of the base station.

### (Supplement Item 5)

The station installation design method according to any one of supplement items 1 to 4, wherein in an accommodation judgement of the terminal in the selected base station in the arrangement step, the transmission rate of the terminal is divided by the number of terminals connected to the selected base station, and when the result is equal to or more than a predetermined threshold value, the terminal is judged to be accommodated in the selected base station.

### (Supplement Item 6)

A station installation design device for performing station installation design for a wireless system including a plurality of base stations having different wireless systems between at least two base stations, the station installation design device includes
a memory, and
at least one processor connected to the memory, wherein
the processor performs
reception power calculation processing that calculates reception power from the base station in each terminal to be an evaluation point for each of one or the plurality of base stations arranged in a temporary installation state in a target area,
transmission rate acquisition processing that converts each calculated reception power into a transmission rate by using a conversion table prepared for each wireless system, and arrangement processing that changes the base station selected from one or the plurality of base stations in the temporary installation state based on a station installation design evaluation index value in consideration of a cost of the base station to an installation state, and making the terminals which can be accommodated in the selected base station accommodated among the unaccommodated terminals, and the processor repeatedly executes the reception power calculation processing, the transmission rate acquisition processing, and the arrangement processing.

### (Supplement Item 7)

A non-transitory storage medium for storing a program that can be executed by a computer to perform station installation design processing for a wireless system including a plurality of base stations having different wireless systems between at least two base stations, wherein
the station installation design processing includes reception power calculation processing that calculates reception power from the base station in each terminal to be an evaluation point for each of one or the plurality of base stations arranged in a temporary installation state in a target area,
transmission rate acquisition processing that converts each calculated reception power into a transmission rate by using a conversion table prepared for each wireless system,
arrangement processing that changes the base station selected from one or the plurality of base stations in the temporary installation state based on a station installation design evaluation index value in consideration of a cost of the base station to an installation state, and makes the terminals which can be accommodated in the selected base station accommodated among the unaccommodated terminals, and processing in which a processor repeatedly executes the reception power calculation processing, the transmission rate acquisition processing, and the arrangement processing.

Although the present embodiment has been described above, the present invention is not limited to the specific embodiment, and various modifications and changes can be made within the scope of the gist of the present invention described in the claims.

### REFERENCE SIGNS LIST

10A, 10B Base station
100 Station installation design device
110 Reception power calculation unit
115 Transmission rate acquisition unit
120 Arrangement unit
130 Output unit
140 Data storage unit
1000 Drive device
1001 Recording medium
1002 Auxiliary storage device
1003 Memory device
1004 CPU
1005 Interface device
1006 Display device
1007 Input device
1008 Output device

1. A station installation design method executed by a computer used as a station installation design apparatus that performs station installation design for a wireless system including a plurality of base stations having different wireless systems between at least two base stations, the station installation design method comprising:
calculating reception power from the base station in each terminal to be an evaluation point for each of one or the plurality of base stations arranged in a temporary installation state in a target area;
converting each reception power calculated in at the calculating into a transmission rate by using a conversion table prepared for each wireless system; and
changing the base station selected from one or the plurality of base stations in the temporary installation state based on a station installation design evaluation index value in consideration of a cost of the base station to an installation state, and making the terminals that can be accommodated in the selected base station accommodated among the unaccommodated terminals, wherein
the calculating, the converting, and the changing are repeatedly executed.

2. The station installation design method according to claim 1, wherein
the repeatedly executing of the calculating, the converting, and the changing is performed while changing an arrangement of the base station in the temporary installation state.

3. The station installation design method according to claim 1, wherein
in the changing, one base station having a station installation design evaluation index value that is best is selected among one or the plurality of base stations in the temporary installation state, and the selected base station is changed to the installation state.

4. The station installation design method according to claim 1, wherein
the station installation design evaluation index value is a value obtained by dividing a number of unaccommodated terminals whose transmission rate that can be received from the base station is equal to or more than a predetermined threshold value by the cost of the base station.

5. The station installation design method according to claim 1, wherein
in an accommodation judgement of the terminal in the base station selected at the changing, the transmission rate of the terminal is divided by a number of terminals connected to the selected base station, and when the result is equal to or more than a predetermined threshold value, the terminal is judged to be accommodated in the selected base station.

6. A station installation design apparatus for performing station installation design for a wireless system including a plurality of base stations having different wireless systems between at least two base stations, the station installation design apparatus comprising:
a processor; and
a memory that includes instructions, which when executed, cause the processor to execute:
calculating reception power from the base station in each terminal to be an evaluation point for each of one or the plurality of base stations arranged in a temporary installation state in a target area;
converting each reception power calculated at the calculating into a transmission rate, by using a conversion table prepared for each wireless system; and
changing the base station selected from one or the plurality of base stations in the temporary installation state based on a station installation design evaluation index value in consideration of a cost of the base station to an installation state, and make the terminals that can be accommodated in the selected base station accommodated among the unaccommodated terminals, wherein the calculating, the converting; and the changing are repeatedly executed.

7. A non-transitory computer-readable recording medium having computer-readable instructions stored thereon which when executed, cause a computer to execute the station installation design method according to claim 1.
